(19) United States
(12) Patent Application Publication
(10) Pub. No.: US 2021/0398134 A1
(43) Pub. Date: Dec. 23, 2021

(54) Biocrypt Digital Wallet

(71) Applicant: ZEU CRYPTO NETWORKS INC., Montreal (CA)

(72) Inventors: Francois DUMAS, Montreal (CA); Yuming QIAN, Richmond Hill (CA)

(73) Assignee: ZEU CRYPTO NETWORKS INC., Montreal, QC (CA)

(21) Appl. No.: 17/284,647

(22) PCT Filed: Oct. 11, 2019
(86) PCT No.: PCT/CA2019/000142

§ 371 Date: Apr. 12, 2021

Related U.S. Application Data
(60) Provisional application No. 62/745,079, filed on Oct. 12, 2018.

(51) Int. Cl. G06Q 20/40; G06Q 20/36; G06Q 20/38; H04L 9/30

(52) U.S. Cl. CPC G06Q 20/40145; G06Q 20/363; G06Q 20/3674; G06K 19/07309; G06Q 20/3825; H04L 9/30; G06Q 20/3829

(57) ABSTRACT

A device and method for using biometric technologies to ensure secure transactions using blockchain technology are disclosed. The embodiments described mitigate at least some security related problems in conventional blockchain digital wallets, particularly those that cannot reliably authenticate user identity. The present disclosure presents a method and apparatus for using authentication and data protection for implementing a blockchain offline wallet using biometrics.

### TECHNICAL FIELD

The present application relates generally to a blockchain system, and more particularly to digital wallets that utilizes of biometric authentication.

### BACKGROUND ART

Blockchain technology maintains a reliable record of transactions by means of collective participation and consensus among participants. A blockchain has often been understood and described as a distributed ledger technology (DLT), jointly maintained by multiple devices called nodes that are interconnected by a network. Blockchain can also be thought of as a distributed database system.

A blockchain system enables any participating node to compute and record all data exchanged in the system through a cryptographic algorithm to a block, and generate a hash value or fingerprint for the block. The hash value is used for linking to the next block and to check with other participating nodes to jointly determine whether the record is true.

A blockchain, as the name implies, is thus composed of blocks that are linked, connected or chained end to end, whereby each block includes information or data for a period of time that is time stamped. Based on the index hash value of the previous block, a new block is connected to the chain.

A transaction in a blockchain must be signed by a private key that belongs to the owner that initiates it. A private key is thus at the core of a blockchain digital asset. Digital assets and associated keys are stored either online or offline.

There are security risks associated with storing private keys online. One risk is that the device used for storage may fail. Once the storage device hardware that holds the private key is damaged, it could lead to any stored digital asset or keys being lost. Assets associated with damaged keys can thus no longer be accessed or retrieved. Some of the early users of Bitcoin have suffered from the loss of private keys because of storage device failure.

A second risk associated with online storage of private keys stored on mobile devices, personal computers, or exchanges, is that the keys may be hacked or stolen. In recent years, a large number of blockchain security incidents have resulted in digital money being stolen due to the theft of private keys stored online.

Numerous incidents have shown that the safety of digital information stored online cannot be guaranteed with absolute certainty. Once information is accessible online, it may be susceptible to theft or tampering as a result exploitation of security holes in operating systems, network protocols, phishing sites, and other loopholes to gain unlawful access without permission.

Some of the problems experienced by users of digital wallets include loss of user identity authentication if the digital wallet is lost. Anyone who obtains the physical wallet can then operate the corresponding data asset.

Another problem is that the security offered by digital wallet is often no better than the level of security that relies solely on mnemonic words. As noted above, offline storage of mnemonic words is susceptible to loss, theft or damage, while online storage is susceptible to unauthorized access, hacking, phishing or theft.

Yet another challenge is that the keys in the digital wallet key cannot be easily exported or easily migrated to other wallet devices.

Accordingly, there is a need for improved systems and methods to safely and securely store sensitive digital information such as private keys for use in blockchain transactions, and mitigate some of the aforementioned problems.

### SUMMARY OF INVENTION

In accordance with one aspect of the present invention there is provided a device comprising: a processor in communication with a non-transitory processor readable medium comprising memory, a display, an input interface, and a biometric sensor, wherein the memory includes processor executable instructions that when executed cause the processor, to perform the steps of: acquiring biometric information from a user using the biometric sensor; generating a feature sequence from the biometric information; generating clue words from the feature sequence; generating a private key from the clue words; and storing the private key in the processor readable medium.

In accordance with one aspect of the present invention there is provided a method of securely generating a key, using device comprising: a processor in communication with a non-transitory processor readable medium comprising memory and a biometric sensor, the method comprising: acquiring biometric information from a user using the biometric sensor; generating a feature sequence from the biometric information; generating clue words from the feature sequence; generating a private key from the clue words; and storing the private key in the processor readable medium.

In accordance with one aspect of the present invention there is provided a method of initiating a blockchain transaction using a wallet device comprising: a processor in communication with a non-transitory processor readable medium comprising memory, a display, an input interface, and a biometric sensor, the method comprising: at the wallet device: receiving a transaction request comprising an address and an amount, from a first computing device; acquiring biometric information from a user using a biometric sensor; generating a bio-vector from said biometric information; comparing the bio-vector to a stored vector to authenticate the user; and upon authentication, signing the transaction request with a private key having a corresponding public key.

### BRIEF DESCRIPTION OF DRAWINGS

In the figures, which illustrate by way of example only, embodiments of the present invention,

FIG. 1 is a simplified schematic diagram of smart wallet devices, exemplary of an embodiment of the present invention, in data communication with computing devices;

FIG. 2 is a simplified block diagram illustrating components of one of the smart wallet devices of FIG. 1;

FIG. 3 is a simplified schematic diagram depicting an exemplary input-output interface for the smart wallet devices of FIG. 1;

FIG. 4 is a flowchart depicting steps in an exemplary process undertaken by an exemplary wallet device of FIG. 1 to generate private keys;

FIG. 5 is a flowchart depicting steps involved in an exemplary process to sign a transaction using keys generated by an exemplary wallet device depicted of FIG. 1 and submit the signed transaction to a blockchain;

FIG. 6 is a flowchart depicting steps involved in an exemplary method for importing or loading private keys into one of the smart wallet devices of FIG. 1;

FIG. 7 is a flowchart summarizing steps involved in an exemplary method of securely exporting private keys and storing them in a memory card; and

FIG. 8 is a flowchart summarizing steps involved in an exemplary process to recover the contents of lost or damaged digital wallet, in to a new device of the type shown in FIG. 2.

### DESCRIPTION OF EMBODIMENTS

A description of various embodiments of the present invention is provided below. In this disclosure, the use of the word “a” or “an” when used herein in conjunction with the term “comprising” may mean “one,” but it is also consistent with the meaning of “one or more”, “at least one” and “one or more than one”. Any element expressed in the singular form also encompasses its plural form. Any element expressed in the plural form also encompasses its singular form. The term “plurality” as used herein means more than one, for example, two or more, three or more, four or more, and the like. Directional terms such as “top”, “bottom”, “upwards”, “downwards”, “vertically” and “laterally” are used for the purpose of providing relative reference only, and are not intended to suggest any limitations on how any article is to be positioned during use, or to be mounted in an assembly or relative to an environment.

The terms “comprising”, “having”, “including”, and “containing”, and grammatical variations thereof, are inclusive or open-ended and do not exclude additional, un-recited elements and/or method steps. The term “consisting essentially of” when used herein in connection with a composition, use or method, denotes that additional elements, method steps or both additional elements and method steps may be present, but that these additions do not materially affect the manner in which the recited composition, method, or use functions. The term “consisting of” when used herein in connection with a composition, use, or method, excludes the presence of additional elements and/or method steps.

A “blockchain” is a tamper-evident, shared digital ledger that records transactions in a public or private peer-to-peer network of computing devices. The ledger is maintained as a growing sequential chain of cryptographic hash-linked blocks.

A “node” is a device on a blockchain network. The device is typically be a computing device having a processor interconnected to a processor readable medium including memory, having processor readable instructions thereon.

The terms “first”, “second”, “third” and the like are used for descriptive purposes only and cannot be interpreted as indicating or implying relative importance.

In the description of the invention, it should also be noted that the terms “mounted”, “linked” and “connected” should be interpreted in a broad sense unless explicitly defined and limited otherwise. For example, it could be fixed connection, or assembled connection, or integrally connected; either hard-wired or soft-wired; it may be directly connected or indirectly connected through an intermediary. For technical professionals, the specific meanings of the above terms in the invention may be understood in context.

In the drawings illustrating embodiments of the present invention, the same or similar reference labels correspond to the same or similar parts. In the description of the invention, it should be noted that the meaning of “a plurality of” means two or more unless otherwise specified; The directions or positions of the terms “up”, “down”, “left”, “right”, “inside”, “outside”, “front end”, “back end”, “head”, “tail”, the orientation or positional relationship shown in the drawings is merely for the convenience of describing the invention and simplifying the description rather than indicating or implying that the indicated device or element must have a particular orientation and be constructed and operated in a particular orientation, and therefore cannot be used as a limitation of the invention. The technical problem to be solved by this invention is to provide an extended design method for blockchain, adding a state chain to maintain the account status information, and making the blockchain run more securely and efficiently.

In a hardware wallet, the private key is stored separately in local storage, isolated from the Internet, and plug and play. A hardware wallet cannot guarantee security. If malicious or otherwise unauthorized person physically gets hold of the hardware wallet, brute force methods may be used to export the private key.

Many of the hardware wallets are recovered after damage, and mnemonics are used to recover the private key completely through a set of words. Many users of hardware wallets copy the mnemonics on paper for confidential safekeeping. Unfortunately, paper records are easily lost, and often prone to mold, loss, damage, discoloring, fire, water damage and the like. Moreover, anyone who acquires the set of mnemonics on paper, can easily recover the private key and steal associated digital assets even if the hardware wallet itself has not been lost. Such problems can be mitigated by clever uses of biometric authentication methods.

Biometric authentication refers to the identification and authentication means realized by the use of biological characteristics of the human body of the user or owner of the hardware. These biological characteristics of the human body include fingerprints, voice or sounds, faces, skeletons, retinas, irises, and DNA (deoxyribonucleic acid), as well as individual behavioral characteristics such as signature movements, walking gait, and strength of hitting keys on a keyboard.

The core of biometric technology is concerned with acquiring these biometric characteristics in real time, converting them into digital information and using a computing device that uses a reliable matching algorithm to complete the process of verifying and identifying personal identity. Biometric identification has been widely used in mobile devices and other contexts that have strict authorization requirements for access. Biometric characteristics that are selected for authentication are those that are globally unique to every human being, exiting universality, uniqueness, stability, and non-reproducibility.

Biometric authentication relies on characteristics of the individual that are not lost, or forgotten, and are exceedingly difficult to forge or counterfeit. Such schemes can be thought of as following the adage “only recognize people, do not recognize things”. Biometric based authentication systems can thus be used to provide a convenient and secure means of protection, that are especially suitable for the identification and protection of user identity in blockchain applications.

Fingerprints are highly specific and complex features that are unique to individuals. The complexity of fingerprints is sufficient for purposes of authentication. A second advantageous feature of fingerprints is their high reliability. To increase reliability, it is only necessary to register more fingerprints, identify more fingers, up to ten (10) fingers, as each fingerprint is unique. To collect multiple fingerprints, a user directly touches the subject finger with the fingerprint collection head. A third advantageous feature of fingerprints is speed and ease of scanning and using fingerprints. Finger prints can be scanned very fast, and are convenient to collect, store and use.

There are already many offline hardware wallet devices on the market, such as the Ledger Nano™, which has only two buttons for confirming or rejecting blockchain transactions. However, the Ledger Nano™ hardware device itself has security problems. In 2018, it was reported that the device was vulnerable to certain types of attack. After a hacker acquires the hardware wallet device physically, the private key could be exported.

Trezor™ is another popular hardware wallet device on the market. It uses the STM32 microprocessor for storage and calculation. It requires a personal identification number or PIN to verify identity during use, but the device also has security problems and cannot always prevent unauthorized use.

If a Ledge Nano™ device or a Trezor™ device is damaged, it is necessary to recover the key. The recovery is made using the twelve (12) pairs of mnemonics generated during device initialization. However, the twelve pairs of mnemonics need to be kept offline in a safe place. Otherwise, recovery of the keys is not possible. In order to prevent the loss or damage of the mnemonic, people think of various methods, including engraving the mnemonic on the steel plate, but this increases the risk of the information leaking into the wrong hands.

Once the mnemonic pairs are obtained by an unauthorized party, they can be used recover all the data in the hardware wallet, without the authorization of the owner. Loss of the mnemonics therefore poses a threat to the security of the keys.

This disclosure describes biometric-related algorithms and technologies that combine with blockchain technology to mitigate at least some security related problems in conventional blockchain digital wallets, particularly those that cannot reliably authenticate user identity. The present disclosure presents a method and apparatus for using authentication and data protection for implementing a blockchain offline wallet using biometrics.

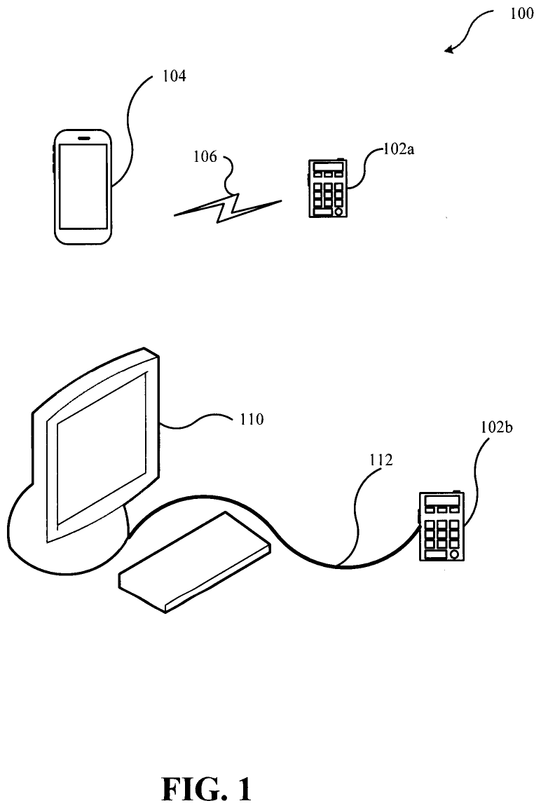

FIG. 1 is a simplified schematic diagram of a system 100 of smart wallet devices 102a, 102b (individually and collectively “devices 102”), exemplary of an embodiment of the present invention, in data communication with computing devices. The depicted system 100 includes a first smart wallet device 102a is depicted in wireless data communication via link 106 which may for example be a Bluetooth link, with mobile device 104.

System 100 also includes a computing device 110, which may be a personal computer (PC), in data communication with a second smart wallet device 102b, via a wired link 112. In the depicted illustration, the wired link 112 is a USB (universal serial bus) cable, although in other embodiments other data communication interfaces and corresponding cables such as serial cables, parallel cables, Ethernet and the like, may be used.

A user of the smart wallet device 102a or 102b (individually and collectively, device 102) may choose to trade on mobile devices such as device 104 or on a personal computers such as computing device 110.

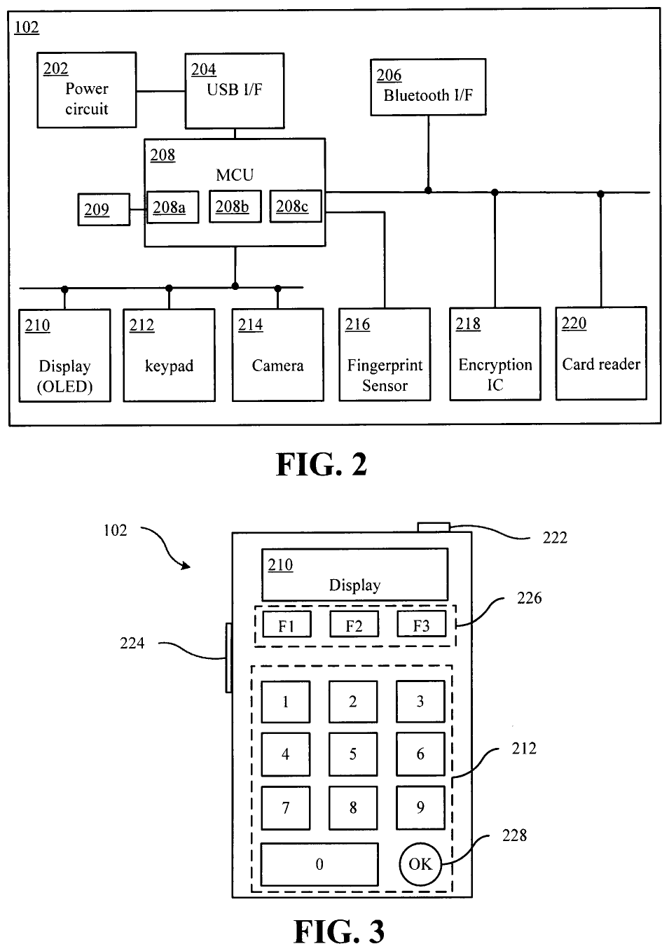

FIG. 2 is a simplified block diagram illustrating components of an exemplary embodiment of the smart wallet device of FIG. 1. Wallet device 102 includes a power circuit 202, a USB interface 204, a Bluetooth interface 206, a processor 208, a display 210, a keypad 212, a camera 214, and biometric sensor 216, an encryption integrated circuit (IC) 218, and a card reader 220.

Power circuit 202 is a power management circuit including a battery, a charging circuit, a voltage detecting circuit, and a power switch control (not shown). Power circuit 202 is used to provide power management for the entire electronic device.

USB interface 204 provides electrical connection to an external power supply as data communication with a USB compliant external device. Upon a USB connection, the power circuit 202 enters a charging state, to charge the internal battery. USB interface 204 provides a data channel for communication with device 110, and by converting USB protocol data to the interface protocol used by the processor 208. In the depicted exemplary embodiment processor 208 is a microcontroller unit (MCU) that uses the USART (universal synchronous and asynchronous receiver-transmitter) protocol.

Bluetooth interface 206 provides a wireless interface that communicates with wireless mobile devices such as device 104. Data transmitted by the mobile device 104 is handed over by Bluetooth interface 206 to the processor 208 for processing. Bluetooth interface 206 provides management of the Bluetooth communication protocol, and performs Bluetooth device pairing, data transmission and conversion of Bluetooth protocol data into USART to communicate with the processor 208.

Display 210 is an output display, which may be an OLED display. Display 210 is used as the primary means of user interaction output, and is utilized in device configuration, displays transaction information, user identity authentication, transaction confirmation, and the like.

Processor 208 is a core computing or processing component of the device 102, and includes a processing unit 208a, random access memory (RAM) storage unit 208b, and a read-only memory (ROM) storage unit 208c. Unencrypted information is stored in storage unit 208c inside the MCU or processor 208.

An encrypted storage 209 is a non-volatile memory used for storing encrypted data such as bio-vector data. Processing unit 208a stores encrypted data to, and reads encrypted data from encrypted storage 209. In other embodiments, encrypted storage 209 may be formed within processor 208.

Encryption IC 218 is an encryption chip for storing a private key and performing associated signature encryption operations. It may be implemented as application specific integrated circuit (ASIC), an field programmable gate array (FPGA) or the like.

Keypad 212 is a numeric or alphanumeric keypad for user input of related information and PIN code.

Biometric sensor 216, in the depicted embedment, is a fingerprint sensor for obtaining and scanning personal fingerprint of a user, for verification.

Card reader 220 is a card reader capable of reading memory cards such as secure digital (SD) cards, TransFlash (TF) cards, and other types of storage using non-volatile memory. Memory cards can be used to import a keystore from other systems into device 102 or to export a keystore from device 102 to external devices.

Camera 214 is an optional component of device 102 used for photographing the face of an operator, in embodiments where facial information is used to assist to assist in identity authentication.

FIG. 3 is a simplified schematic diagram depicting an exemplary input-output interface for device 102.

Input interface 222 is a USB interface or port for charging and communicating with an external device such as personal computer, and may be used to send encrypted data to the personal computer or other external device.

As noted above, display 210 is used to interact with a user and in the depicted embodiment, is implemented as an organic light emitting diode (OLED) screen.

Display 210 is used to guide the user, after device 102 is initialized, to create a new private key or use the information provided by the user to recover the private key.

Function keys 226, include one or more function keys that cooperate with display 210 to realize function selection. When the function selection is needed, the corresponding key among function keys 226 positioned at the bottom of the screen or display 210 can be used to interact with device 102.

For example, transaction information is displayed during normal use and the user is required to cooperate using the function keys 226, the keypad 212 and the fingerprint button 228 to confirm or reject transactions.

Numeric keypad 212 includes a plurality of numeric keys are illustrated, and is used for entering information.

In embodiments where with heighted security requirements, two-factor authentication may be used. In addition to using information from one or more fingerprints, numeric keypad 212 is used to enter a 4 to 8 digit PIN code, which is required for transaction confirmation.

A fingerprint button 228 is used for confirming input content. The device 102 can save the feature values of multiple fingerprints. When device 102 initializes the private key, randomly generated prompts are used to match the user fingerprint information to generate the private key. During the transaction, the transaction can continue after one or more fingerprints match successfully.

A card slot 224, is adapted to receive a TF card into the card reader 220. The card may be an SD card or the like. A user may then export the private key into the card inserted into slot 224.

A user has many flexible options. If a hardware wallet device such as device 102 is no longer needed, digital assets contained therein can be transferred to other types of hardware wallet devices and/or to software wallets. Users need only insert an appropriate type of memory card into the card slot 224 and follow instructions as they are displayed on display 210. Digital certificate export operation. During the operation, multiple fingerprint matching authentication and PIN code confirmation are required.

In operation, exemplary wallet device 102 supports two communication modes: a wired communication mode via a USB port and a wireless communication via Bluetooth. Although the exemplary illustration in FIG. 1 depicts only USB and Bluetooth communication links, other embodiments may utilize other wired or wireless communication links and associated protocols.

The user connects the smart wallet device 102b to a computing device 110 that may be PC or a laptop, via link 112 such as a USB cable. The computing device 110 executes related transaction software on the PC for digital asset trading, and sends the transaction information to the smart wallet device 102.

When computing device 110 needs to conduct transactions, the transaction information is sent to device 102b through the USB channel in link 112. The device 102b encrypts the data using the built-in private key, confirms user identity using fingerprint button 228, and returns the transaction confirmation information to the PC or computing device 110 through the USB channel. In this way, only the signed transaction data and returned to the computing device 110 while the private key remains in the wallet device 102 ensuring security of the private key.

In a variation of the above exemplary embodiment, the user may be required to provide a PIN code in addition to fingerprint for identity verification.

A user may also choose to connect to digital wallet device 102a via Bluetooth using mobile device 104. As a first step, Bluetooth pairing is required between these Bluetooth complaint devices 102a, 104. After Bluetooth communication is established, the mobile device 104 transmits transaction related information to the digital wallet device 102a. The digital wallet device 102a receives the data, signs the received data using the private key stored thereon, and transmits signed data back to a mobile application executing on device 104 for use in the transaction.

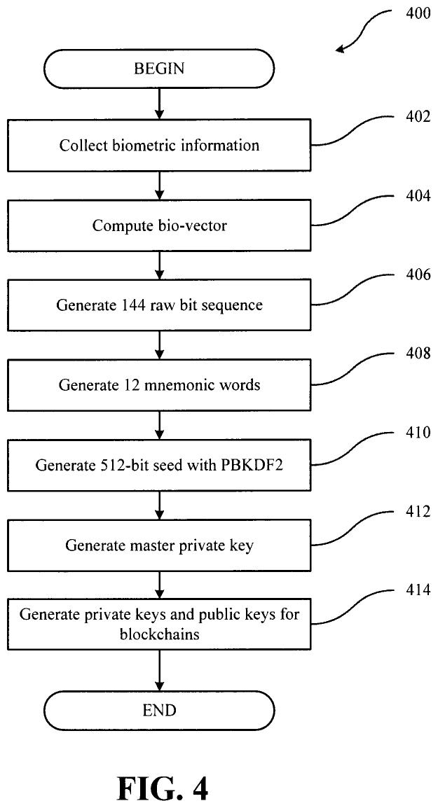

FIG. 4 illustrates a flowchart 400 depicting steps in an exemplary process undertaken by the exemplary device 102 to generate private keys.

In step 402, the device 102 collects one or more multiple biometric information, such one or multiple fingerprints and/or facial features.

In step 404, the device 102 generates a 128-bit feature sequence called bio-vector from the biometric information acquired in step 402.

In step 406, the device 102 uses a cyclic redundancy check (CRC) algorithm, utilizing the well-known generator polynomial g(x)=x¹⁶+x¹⁵+x²+1 to generate a 16-bit checksum for the feature sequence. Appending this 16-bit checksum to the 128-bit number results in a 144-bit sequence.

In step 408, the sequence is divided up into 12-bit data-words, to form twelve (12) numbers that are each 12-bit binary data-words. A table of mnemonics is the used to map each 12-bit binary data-word into a corresponding mnemonic word to form a 12-word mnemonic string. The mnemonic string is displayed. If device 102 is ever damaged, data can be recovered by biometric information or restored using the mnemonic string. In device 102, the biometric information is sufficient to restore data. However, the mnemonic words are generated and kept in exemplary embodiments of the present invention, as they may be needed to restore private keys in other digital wallets, where the mnemonic words are needed to restore the private keys. However, users of device 102 need not remember the generated mnemonics since exactly the same words can be generated with their biometric features.

In step 408, smart wallet device 102 generates a 512-bit seed from the mnemonic string using the PBKDF2 (Password Based Key Derivation Function 2) cryptographic algorithm.

In step 410, smart wallet device 102 generates the master private key and various sub-keys based on the seed derived in step 408, using the HMAC-SHA512 algorithm to generate the wallet address of each blockchain. A wallet address is generated by blockchain node, and imported into a hardware wallet device 102. A wallet device such as device 102 is only a storage device, not a node in blockchain. As noted above, computer device 110 may be part of a blockchain and may participate in transaction. For transactions that require the use of private keys to encrypt or decrypt digital information, computing device 110 sends the digital information in the form of bits or bytes to wallet device 102, which in turn encrypts or decrypts the received bits as required and sends back the result to computing device 110. In these scenarios, private keys stored on wallet device 102 are never transmitted to the node such as computing device 110.

In cases where one needs to transfer the digital asset of a blockchain address in the wallet to another account, the private key of the corresponding blockchain in the wallet is needed to transfer the desired amount and the other party's transfer address to confirm the signature. After receiving the transfer request, a smart contract uses the wallet public key to authenticate the signature, and to confirm that the transaction was initiated by the owner of the wallet.

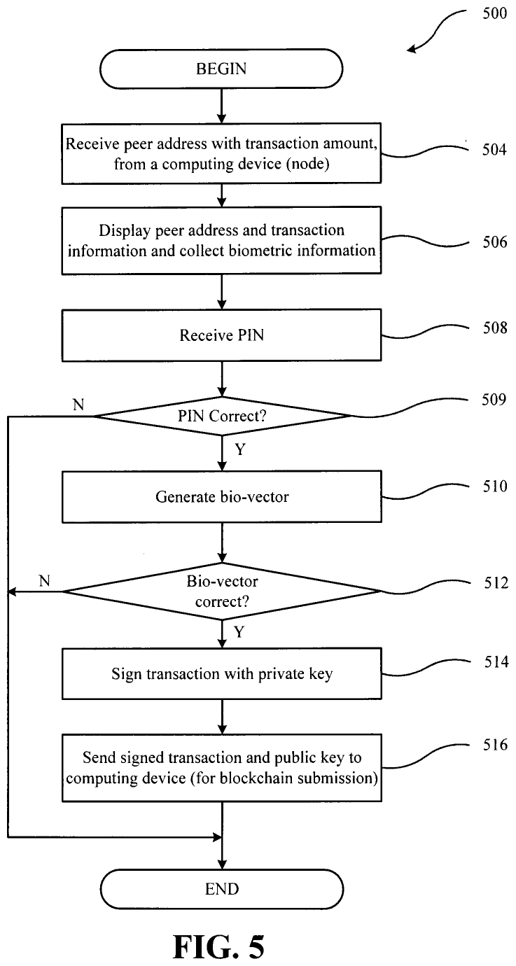

FIG. 5 illustrates a flowchart 500 depicting steps involved in an exemplary process to sign a transaction using keys generated by exemplary device 102.

After a blockchain application executing on computing device 110 accepts the transfer request, computing device 110 sends the transfer amount and the receiving wallet address in the transfer request, to the hardware wallet device 102.

Accordingly, in step 504, device 102 receives a peer address with a transaction amount, from device 110 in response to the transaction request.

In step 506, the hardware wallet device 102 displays the transfer amount and the address of the receiving party on its OLED display 210.

In step 508, the hardware wallet device 102 prompts for the transaction PIN code. In step 510, hardware wallet device 102 receives a PIN code. If the PIN code is incorrect (step 509) the process terminates. Otherwise, in step 510, hardware wallet device 102 generates a bio-vector, after prompting the user to confirm with the fingerprint identification button 228, and receiving the fingerprint.

In step 512, hardware wallet device 102 checks if the bio-vector is correct. To do so, in this embodiment, device 102 uses the acquired fingerprint to generate feature vectors, align the fingerprint vector with the fingerprint vector saved in encrypted storage 209 inside device 102 when the wallet is initialized. During authentication, device 102 generates a bio-vector again and compares it with the stored vector encrypted storage 209.

If the PIN code is correct and the fingerprints are the same, the certificate is verified. The digital wallet device 102 uses the private key stored in the encryption IC 218 to sign the address of the other or receiving party and the amount of the transfer (step 514).

In step 516, hardware wallet device 102 attaches the public key of the wallet to the signed transaction information and sends it to device 110. The process of flow chart 500 then terminates.

The computing device 110 receives the signed transaction with the public key from device 102 and communicates with the blockchain to submit the transaction. The blockchain verification of the signature completes the transaction.

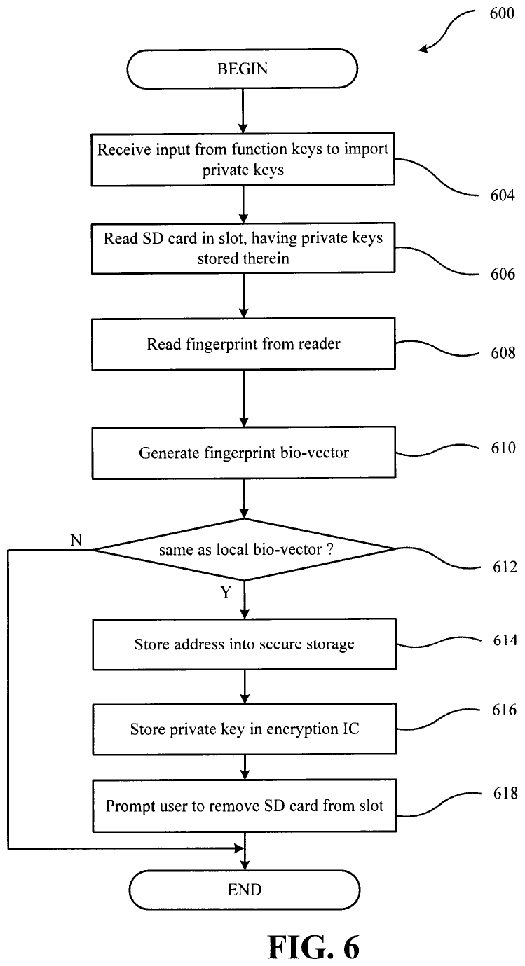

FIG. 6 illustrates a flowchart 600 depicting steps involved in an exemplary method of loading private keys into exemplary device 102 of FIG. 1.

As will be appreciated, users may need to transfer digital assets from other hardware wallets or from software wallets in the smart wallet device 102. The user then presses one of function keys 226 at the bottom of the screen display 210 corresponding a menu option to import keys from other wallets.

Accordingly, in step 604, wallet device 102 receives input from function keys 226 to import private keys from the SD card. The user inserts an SD card with a different wallet key in to the card slot 224.

Device 102 automatically discovers the new SD card in card slot 224 and reads the SD card having private keys stored therein (step 606).

As the user presses the fingerprint recognition button 228 to confirm the import command, device 102 reads the fingerprint biometric data using the fingerprint sensor 216.

The device 102 collects user fingerprints and generates feature vectors (step 610).

Device 102 then compares the generated fingerprint feature vector with the stored biometric feature vector in storage 209 (step 612). If there is a match (step 612), device 102 saves the imported account address in the encrypted storage 209 (step 614).

Device 102 then saves the corresponding private key into the encryption IC 218 (step 618) and optionally prompts the user to remove the SD card from slot 224 (step 618). The process of flowchart 600 executed by device 102 then terminates.

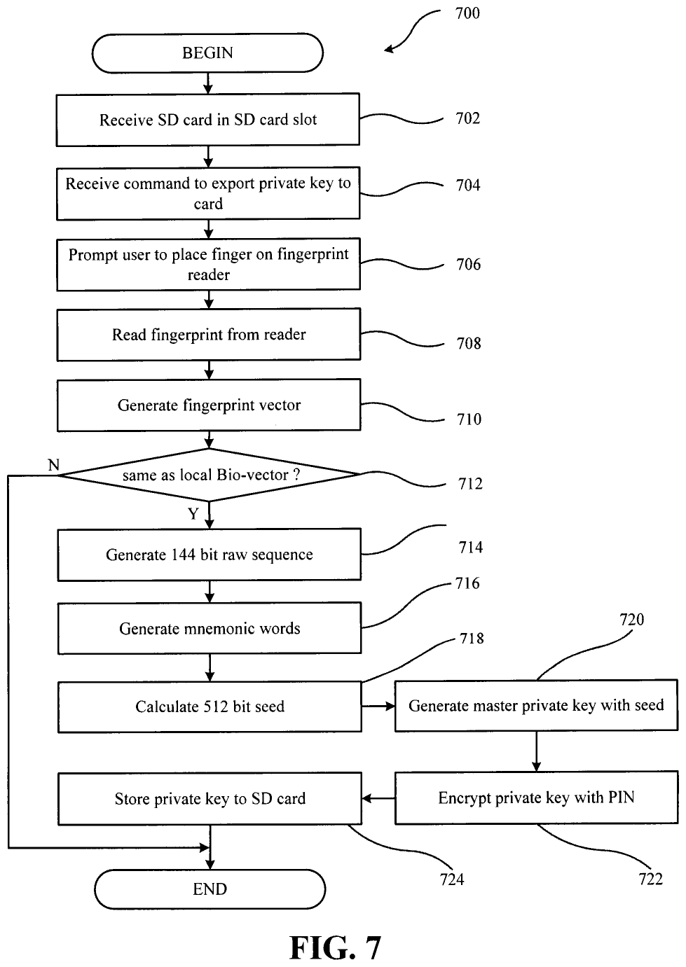

FIG. 7 depicts a flowchart 700 summarizing steps involved in a processor or method, exemplary of an embodiment of the present invention, for exporting private keys from smart wallet device 102 and storing them securely in an SD card.

In step 702, the smart wallet device 102 receives an SD card in card slot 224.

In step 704, the smart wallet device 102 receives input from function keys 226 to export private keys to the SD card.

In step 706, the smart wallet device 102 prompts the user to place a finger on the finger print button 228 and scans the fingerprint using the biometric sensor 216 (step 708).

Device 102 generates fingerprint vector (step 710) and then compares the generated fingerprint vector with the stored local biometric vector (step 712). Upon comparison (step 712), if there is a match then device 102 generates a 144-bit raw sequence (step 714)

In step 716, mnemonic words are generated by device 102. As noted earlier with reference to FIG. 4, the 144-bit sequence may be divided up into 12-bit data-words, to form twelve of 12-bit numbers, which are then mapped to mnemonics using a table of mnemonics to form a 12-word mnemonic string. of course, other means of converting the bit-string into a mnemonic string will be known to persons of skill in the art.

In step 718, smart wallet device 102 generates a 512-bit seed from the mnemonic string.

In step 720, smart wallet device 102 generates the master private key from the seed. In step 722, smart wallet device 102 encrypts the private key with a PIN; and in step 722, device 102 stores the encrypted private key on the SD card.

Optionally, the device 102 may prompt the user to remove the SD card from the slot 224 upon completion of the process of exporting summarized in flowchart 700.

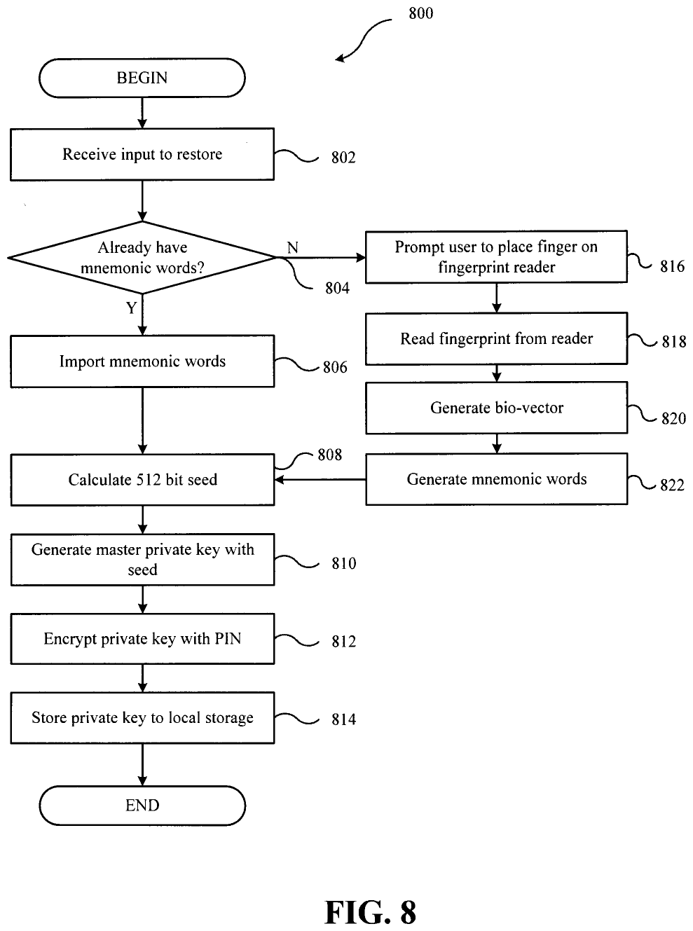

FIG. 8 is a flowchart 800 summarizing steps involved in an exemplary process executed by a new device 102 to recover the contents of a lost or damaged digital wallet.

If an existing wallet hardware is damaged or lost, the user purchases a new device similar to wallet device 102 and restores the wallet data. An exemplary process is described below.

At step 802, device 102 receives instructions or input to restore wallet data.

At step 804, device 102 determines if the user already has mnemonic words by for example prompting the user and getting a response input using keypad 212 or function keys 226.

If the user has mnemonic words, at step 806 the mnemonic words are imported. This may be done with keypad 212. As noted above, keypad 212 may be alphanumeric. Alternately, even keypads with primarily numeric keys can be used to generate letters of the alphabet, for example, by pressing a particular numeric key once, twice, three, or more times to input one of its corresponding letters.

In step 808 wallet device 102 generates a 512-bit seed from the mnemonic string of clue words or mnemonic words received or imported in step 806.

In step 810, device 102 generates the master private key from the seed.

In step 812, device 102 encrypts the private key with a PIN.

In step 814, device 102 stores the encrypted private key to local storage on encryption IC 218.

If at step 804, it is determined that the user does not have mnemonic words, at step 816, then the user is prompted to place a finger on the finger print reader button 228.

In step 818, device 102 reads the fingerprint using the fingerprint sensor 216.

At step 820, bio-vector is generated from the finger print scanner during step 818, and clue words are generated (step 822).

As discussed earlier, in one exemplary embodiment the generation of clue words (step 822) involves the generation of a 128-bit feature sequence from the biometric information or fingerprint. Device 102 then uses a cyclic redundancy check algorithm, to generate a CRC checksum for the feature sequence, and appends it to create a bit sequence having a checksum. This sequence is divided up into data-words (e.g., 12-bit each), and a table of mnemonics is the used to map each binary data-word into a corresponding mnemonic word to form a mnemonic string. In some embodiments, the table of mnemonics may be hardcoded in the MCU or processor 208.

After step 822 is completed, the exemplary process continues to step 808 and executes the subsequent steps as discussed above.

Advantageously, embodiments of the present invention solve problems that plague current hardware blockchain wallet related to identity verification or authentication. The use of biometric information to in the process of key generation eliminates the need for forced memory prompts, which in turn enhances the security of hardware wallets.

Exemplary hardware wallet devices and their variants communicate can with mobile devices and other computing devices such as personal computers and laptops, Macintosh computers and laptops, workstations and others using wired and wireless means. The hardware wallets described works with the mobile or desktop applications to achieve seamless integration with the existing blockchain networks.

Having thus described, by way of example only, embodiments of the present invention, it is to be understood that the invention as defined by the appended claims is not to be limited by particular details set forth in the above description of exemplary embodiments as many variations and permutations are possible without departing from the scope of the claims.

What is claimed is:

1. A device comprising: a processor in communication with a non-transitory processor readable medium comprising memory, a display, an input interface, and a biometric sensor, wherein the memory includes processor executable instructions that when executed cause the processor, to perform the steps of:
a) acquiring biometric information from a user using the biometric sensor;
b) generating a feature sequence from the biometric information;
c) generating clue words from the feature sequence;
d) generating a private key from the clue words; and
e) storing the private key in the processor readable medium.

2. The device of claim 1, further comprising a secure storage forming part of the processor readable medium, wherein the private key is stored in the secure storage.

3. The device of claim 1, further comprising a hardware encryption circuit for performing one or more of step b), step c) or step d).

4. The device of claim 1, wherein the biometric sensor comprises a fingerprint reader.

5. The device of claim 1, wherein the steps further comprise:
a) generating a checksum for the feature sequence; and
b) appending the checksum to the feature sequence.

6. The device of claim 1, wherein said generating the clue words comprises:
a) dividing up the feature sequence into a plurality of data-words; and
b) mapping each data-word in the plurality of the data-words into a mnemonic.

7. The device of claim 6, wherein said each data-word, is mapped to its corresponding mnemonic using a table of mnemonics.

8. The device of claim 1, further comprising a communications interface to communicate with a computing device, wherein the communication interface comprises at least one of a wired interface and a wireless interface.

9. The device of claim 8, wherein the communication interface is said wired interface and comprises a USB interface.

10. The device of claim 8, wherein the communication interface is said wireless interface and comprises a Bluetooth interface.

11. The device of claim 5, wherein the step of generating a checksum comprises generating a cyclic redundancy check (CRC) checksum.

12. The device of claim 11, wherein the CRC is generated using the generator polynomial g(x)=x¹⁶+x¹⁵+x²+1

13. The device of claim 13, wherein the checksum is 16-bits and the feature sequence prior to said appending is 128-bits.

14. The device of claim 6, wherein said each data-word is 12-bits.

15. The device of claim 1, wherein the steps further comprise: generating a seed from the clue words.

16. The device of claim 11 wherein the seed is generated using the PBKDF2 (Password Based Key Derivation Function 2) cryptographic algorithm.

17. A method of securely generating a key using a device, the device comprising: a processor in communication with a non-transitory processor readable medium comprising memory and a biometric sensor, the method comprising:
acquiring biometric information from a user using the biometric sensor;
generating a feature sequence from the biometric information;
generating clue words from the feature sequence;
generating a private key from the clue words; and
storing the private key in the processor readable medium.

18. A method of initiating a transaction using a wallet device comprising: a processor in communication with a non-transitory processor readable medium comprising memory, a display, an input interface, and a biometric sensor, the method comprising:
at the wallet device:
a) receiving a transaction request comprising an address and an amount, from a first computing device;
b) acquiring biometric information from a user using a biometric sensor;
c) generating a bio-vector from said biometric information;
d) comparing the bio-vector to a stored vector to authenticate the user; and
e) upon authentication, signing the transaction request with a private key having a corresponding public key, to form a signed transaction request.

19. The method of claim 18, further comprising, transmitting said signed transaction request to the first computing device along with the public key.

20. The method of claim 18, further comprising, displaying the address and transaction amount on said display prior to said signing.

21. The method of claim 18, further comprising,
receiving a personal identification number (PIN) after said receiving said transaction request; and
comparing the received PIN to a stored PIN to authenticate the user.

22. A method of loading private data into a device, the device comprising: a processor in communication with one or more of a non-transitory processor readable medium comprising memory, a display, an input interface, a secure storage, and a biometric sensor, each in communication with the processor, the method comprising:
receiving input indicative of a loading command from the input interface;
receiving the private data comprising a private key;
acquiring biometric information from a user using the biometric sensor;
generating a bio-vector from said biometric information;
comparing the bio-vector to a stored vector to authenticate the user; and
upon authentication, storing said private data in said secure storage on the device.

23. The method of claim 22, wherein the private data further comprises an account address associated with the private key.

24. The method of claim 22, wherein the private data further comprises an account address associated with the private key.

25. The method of claim 22, wherein the device further comprises a card reader and the private data is received from a memory card via said card reader.

26. A method of exporting private data from a device, the device comprising: a processor in communication with one or more of a non-transitory processor readable medium comprising memory, a display, an input interface, a secure storage, and a biometric sensor, each in communication with the processor, the method comprising:
receiving input indicative of an export command from the input interface;
acquiring biometric information from a user using the biometric sensor;
generating a bio-vector from said biometric information;
comparing the bio-vector to a stored vector to authenticate the user; and
upon authentication, retrieving said private data from said secure storage on the device and storing the private data into the processor readable medium.

27. The method of claim 26, wherein said device comprises a card reader, and the processor readable medium comprises memory card received in said card reader, wherein storing the private data comprises storing the private data into the memory card.

28. The method of claim 26, further comprising:
prior to said storing the private data,
generating a bit sequence from said bio-vector;
generating mnemonics from said bit sequence;
calculating a seed from the mnemonic words;
generating a master private key with the seed;
encrypting the private key with a personal identification number (PIN); and
storing the private key as part of said private data.
